(19) United States
(12) Patent Application Publication
(10) Pub. No.: US 2020/0361705 A1
(43) Pub. Date: Nov. 19, 2020

(54) COMBINATION TABLE AND TRASH RECEPTACLE ASSEMBLY

(71) Applicants: Doug DeBerti, Arroyo Grande, CA (US); Brad DeBerti, Arroyo Grande, CA (US)

(72) Inventors: Doug DeBerti, Arroyo Grande, CA (US); Brad DeBerti, Arroyo Grande, CA (US)

(21) Appl. No.: 16/415,888

(22) Filed: May 17, 2019

(51) Int. Cl. B65F 1/02; A47B 37/00; A47B 9/00; B65F 1/14

(52) U.S. Cl. CPC B65F 1/02; B65F 1/1473; A47B 9/00; A47B 37/00

(57) ABSTRACT

A combination table and trash receptacle includes a table top mounted on an upper perimeter edge of the container by a plurality of legs. Each leg has a lower end with a channel or notch for receiving the upper edge of the container. The legs are adjustable so as to fit different sized containers. The table can be quickly and easily mounted on the container without the use of fasteners or tools.

### FIELD OF THE INVENTION

The invention is directed toward a table top and trash receptacle combination for use in various settings.

### BACKGROUND OF THE INVENTION

Workshops, garages, and other facilities that do manufacturing, maintenance, and repair work on all types of objects, such as machines, equipment, and automotive, typically have a need for trash disposal. Garbage cans and other containers or receptacles are often used for collecting trash and garbage for later disposal. These facilities also have a need for tables to support tools, supplies, small parts, food, drinks, and other pieces or objects. The garbage can containers and tables are separate pieces, each of which use floor space, and may require individual movement around the workshop or facility. A simple combined table top and trash container would simplify movement, reduce movement time, and minimize space utilization.

Therefore, a primary objective of the present invention is the provision of a combination table top and trash receptacle assembly which is lightweight and can be quickly and easily moved from one location to another in a shop, garage, or other building or facility.

Another objective of the present invention is the provision of a table and garbage can assembly which functions simultaneously to support various articles and for disposal of waste materials.

A further objective of the present invention is the provision of a table top which can be quickly and easily mounted on top of a garbage can, drum, or barrel.

Still another objective of the present invention is the provision of a table top having adjustable legs to fit on top of various sized containers.

Another objective of the present invention is the provision of a table top which can be retrofitted onto the perimeter edge of a garbage can or other container without fasteners or the use of tools.

Yet another objective of the present invention is the provision of a table top having legs which slide downwardly over the upper perimeter edge of a garbage can or 55-gallon drum so as to support the table top at a distance spaced above the open end of the can or drum.

Another objective of the present invention is the provision of a table top assembly for use on garbage cans and other containers, which is economical to manufacturer, and safe and durable in use.

These and other objectives become apparent from the following description of the invention.

### SUMMARY OF THE INVENTION

A table top mounts onto the upper perimeter edge of a garbage can, 55-gallon drum, barrel, or other container so as to form a combination table and trash receptacle assembly. The container has an open upper end with the perimeter rim, and the table mounts to the rim of the container via a plurality of legs. The lower end of each of the legs has a channel or notch to receive the perimeter rim of the container, without the use of fasteners or tools. The legs can be adjusted radially inwardly and outwardly so as to accommodate containers having different diameters. The table surface is spaced above the upper end of the container by the legs, such that trash, and other waste material can be placed into the container while a table top is mounted on the container. The container may have wheels on the bottom for rolling the assembly. The top of the table may be round, square, or any other desired shape. The table top may also include holes for holding tools, such as screwdrivers. The table top has a perimeter lip or flange to prevent objects from inadvertently or accidentally sliding off the top surface. The table top can be quickly and easily removed from the container so that contents can be emptied from the container.

### BRIEF DESCRIPTION OF THE DRAWINGS

FIG. 1 is a perspective view of the combination table and trash receptacle assembly according to the present invention.

FIG. 2 is a side elevation view of the assembly.

FIG. 3 is an exploded view of the table top and a garbage cans, according to the present invention.

FIG. 4 is the bottom plan view of the table top with the legs extended to a maximum diameter.

FIG. 5 is another bottom plan view of the table top with the legs retracted to the smallest diameter.

FIG. 6 is an exploded view showing the adjustment means for the legs of the table top.

FIG. 7 is a perspective view of an alternative embodiment of the table top, according to the present invention.

FIG. 8 is a bottom view of the table top shown in FIG. 7.

FIG. 9 is a side elevation view of the table top shown in FIG. 7.

FIG. 10 is an enlarged perspective view showing the ratcheting leg of the table top embodiment shown in FIG. 7.

FIG. 11 is a perspective view of a third embodiment of the table top, with an organizer or ring on the perimeter of the table top.

FIG. 12 is a bottom view of the embodiment shown in FIG. 11.

FIG. 13 is a sectional view of the organizer or ring on the embodiment shown in FIG. 11.

### DETAILED DESCRIPTION OF THE DRAWINGS

The table and trash container combination of the present invention is generally designated in the drawings by the reference numeral 10. The combination or assembly 10 includes a table top 12 and a container 14, such as a garbage can, a 55-gallon drum, a barrel, or the like. The container 14 has an open top end 16 with a perimeter edge 18. The container may have wheels 20 for easy rolling along a floor. While the container 14 may take various forms, no modifications to the container are required for use with the table top 12.

The table 12 includes a top panel 22 and a plurality of legs 24. The legs 24 extend outwardly from the bottom surface of the top 22 for mounting on the perimeter edge 18 of the container 14. More particularly, in a preferred embodiment, the lower ends of the legs 24 have an inverted U-shaped channel or recess 26 sized to fit over the perimeter edge 18 of the container 14. The opposite sides of the channel 26 may be flared outwardly, so that the channel has a slightly wider mouth than the base of the channel, for ease of mounting the table 12 onto the container 14. It is understood that the legs 24 of the table 12 may be mounted to the container 14 in other convenient manners, without departing from the scope of the present invention.

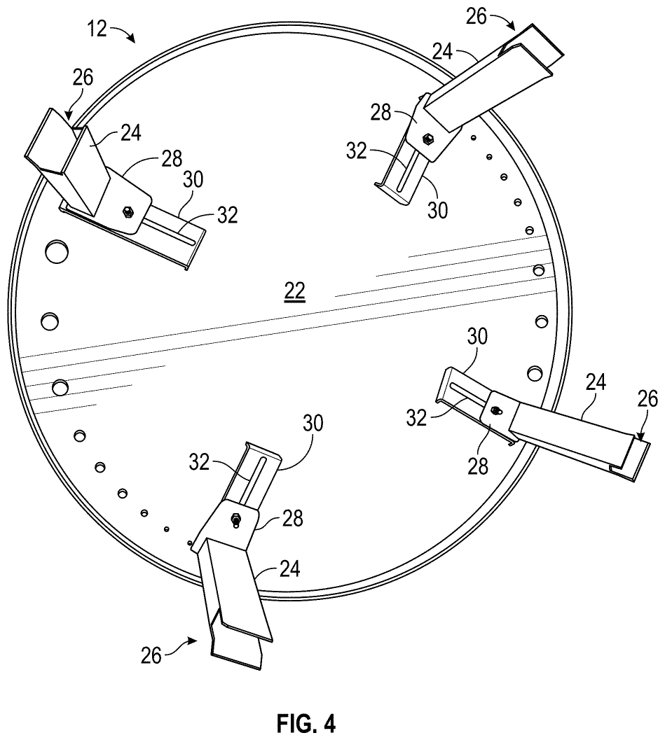

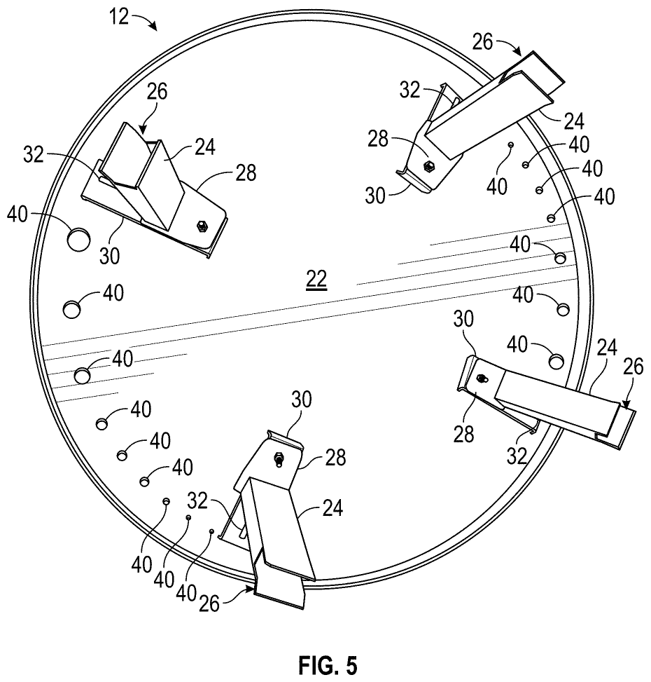

The legs 24 are adjustably mounted on the table top 22 so that the spacing between the legs can be changed to accommodate different sized containers 14. In the preferred embodiment, shown in the drawings, the upper end of each leg 24 includes a bar or a plate 28 extending perpendicular to the leg, and inwardly toward the center of the table top 22. Each plate 28 is slidably mounted on a track 30 which is welded or otherwise secured to the bottom of the table top 22. Each track 30 extends radially, with a slot 32. A bolt 34 extends through the slot 32 and through a hole in the plate 28, such that the plate 20 can be secured or fixed anywhere along the track 30 by tightening a nut 36 onto the bolt 34. Thus, the legs 24 can be moved from an expanded position defining an enlarged diameter, as shown in FIG. 4, to a retracted position defining a small diameter, as shown in FIG. 5.

It is understood that the adjustable movement of the legs 24 on the table top 22 can be accomplished using other means. For example, the slots 32 can be formed in the table top 22, without using the brackets 30, though the brackets 30 eliminate a bolt head residing on the upper surface of the table top 22.

The table top 22 may be provided with additional features, such as a perimeter lip or flange 38, which prevents objects from accidentally sliding off of the table top. Also, one or more holes 48 may be provided in the table top 22, for holding tools or other objects, such as screwdrivers. The holes may have different diameters, as best seen in FIGS. 4 and 5.

The table 12 can be quickly and easily mounted on top of the container 14, without the use of fasteners or tools, via the channels 26 in the legs 24. The legs space the table top 22 apart from the top end 16 of the container 14, such that the assembly 10 provides the simultaneous functions of a table for supporting tools, parts, food, drinks, and the like, and a container for receiving trash and other waste materials. When the container 14 needs to be emptied, the table 12 can be easily lifted off of the container and set aside, so that the container can be rolled, carried, or otherwise moved for dumping or for removing a trash bag.

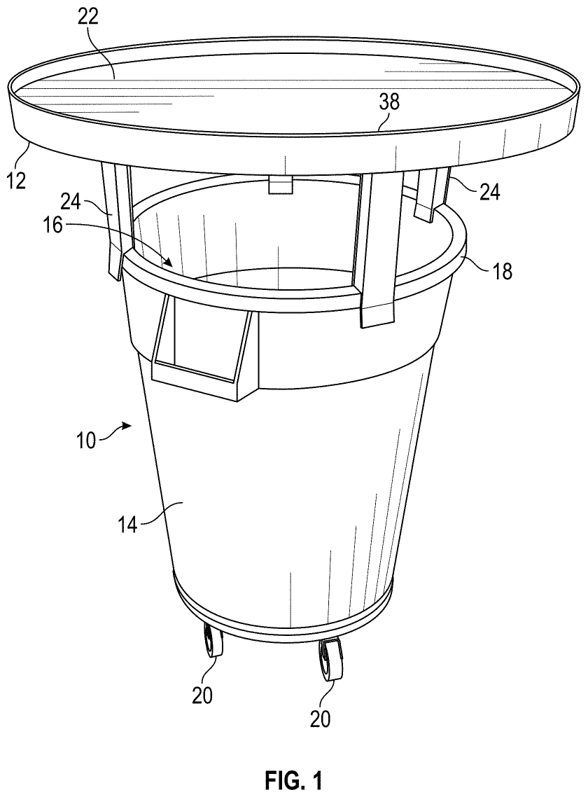

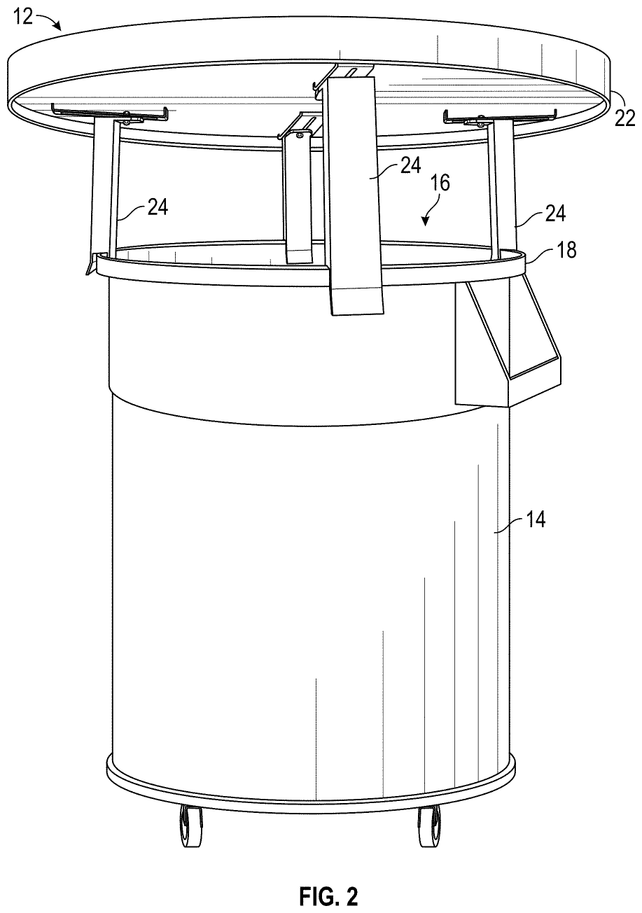

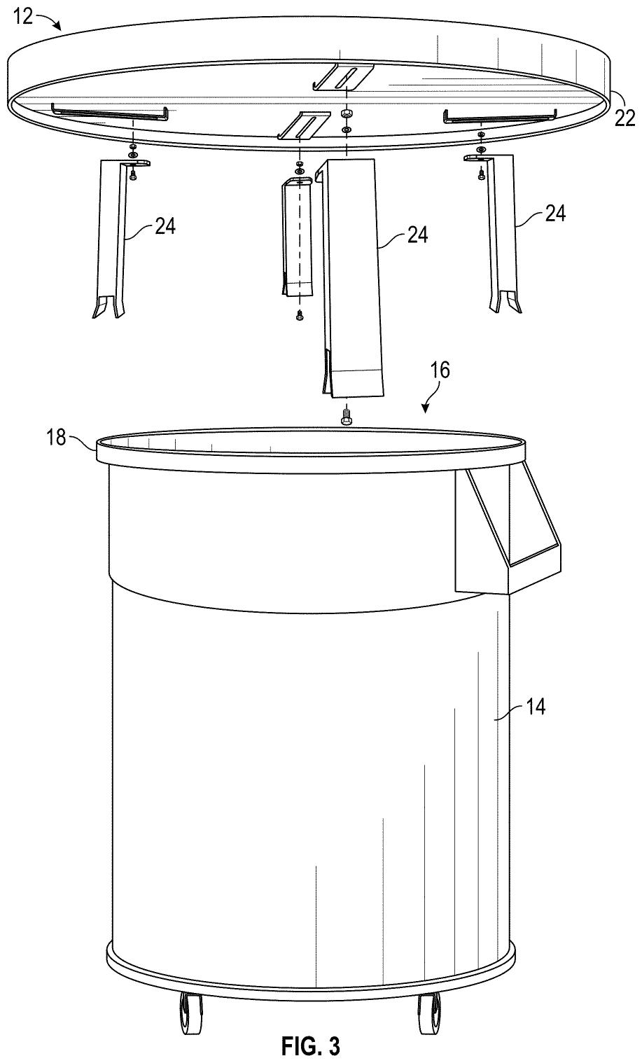

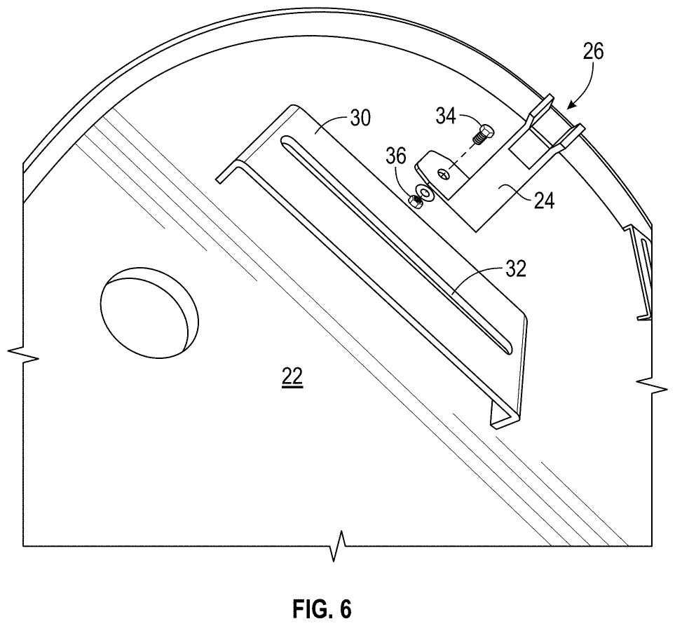

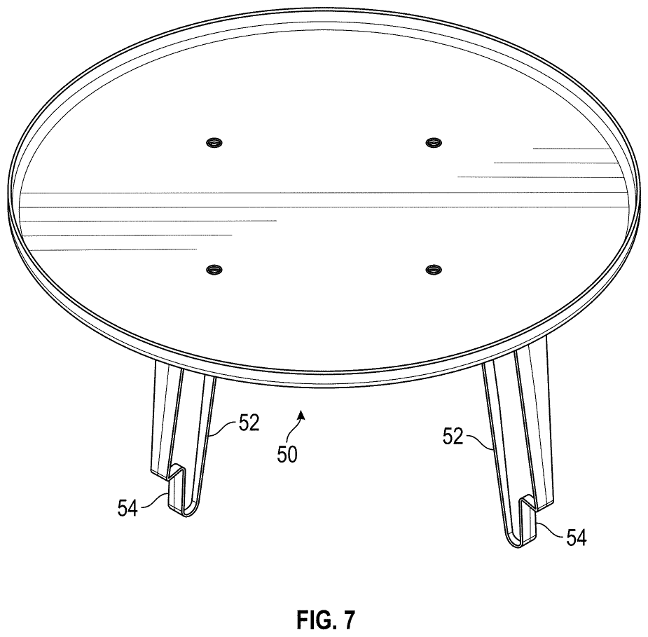

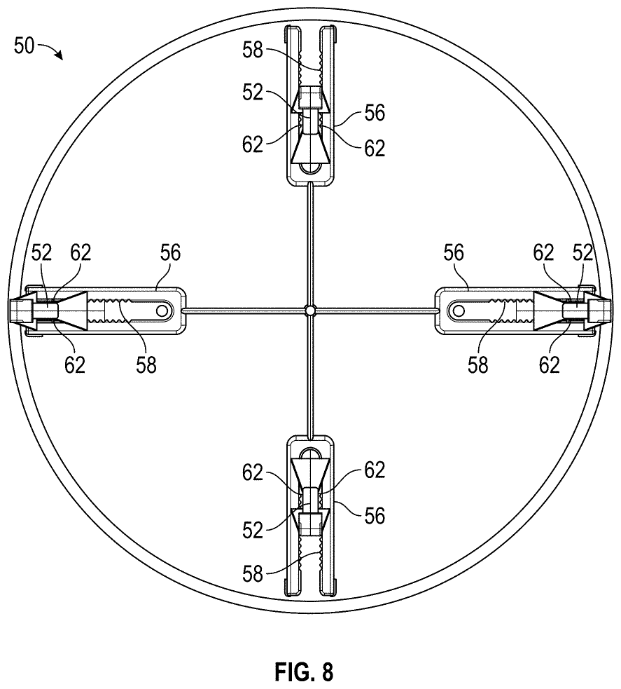

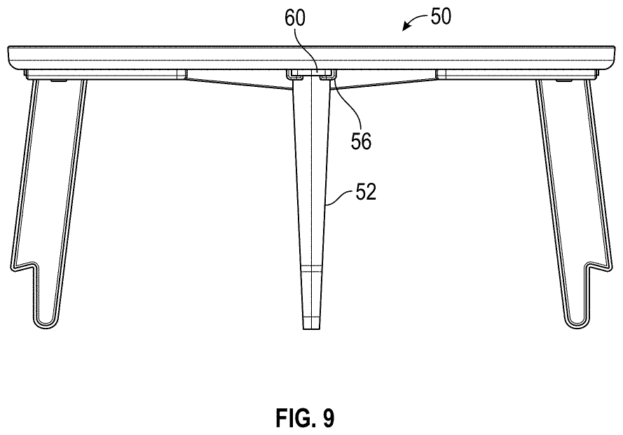

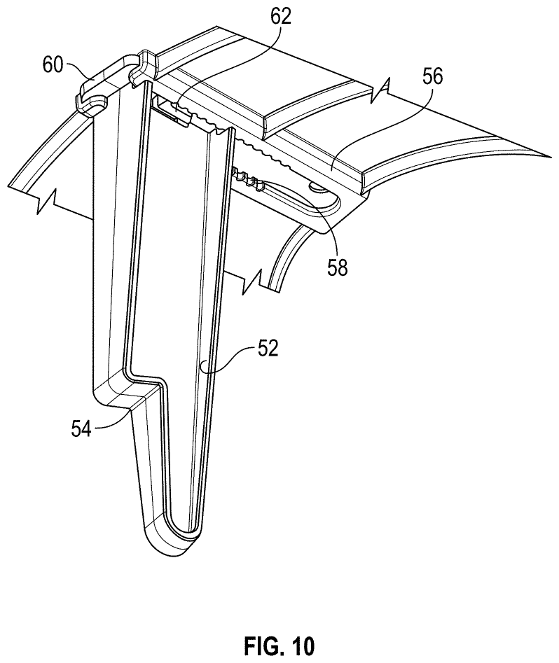

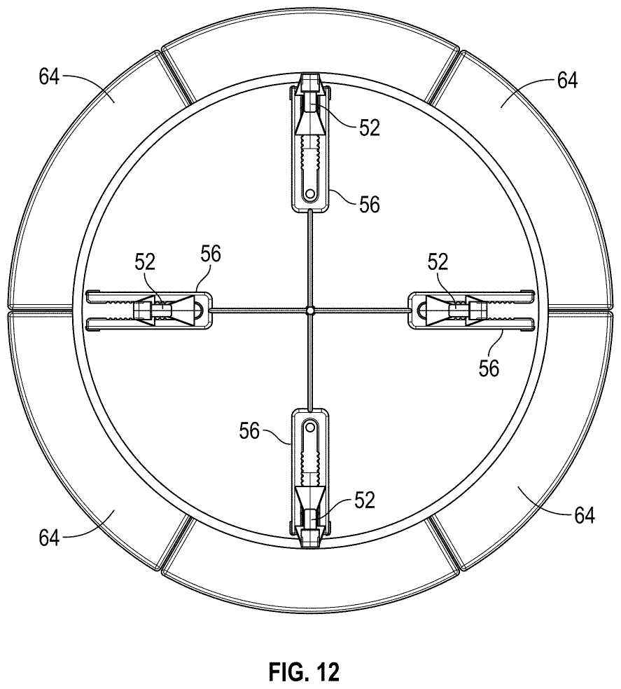

An alternative embodiment of the table top is shown in FIGS. 7-10, and is designated by the reference 50. The table top 50 has a different leg structure than the table top 12 shown in FIGS. 1-6. More particularly, the legs 52 of the table 50 each have an inverted L-shaped notch 54, rather than the U-shaped channel 26, for mounting the table 50 onto the container 14. Also, the legs 52 are attached to the bottom of the table 50 by a ratchet mechanism 56 to allow the adjustment of the leg position so as to accommodate different sized containers 14. As seen in FIGS. 8-10, a track 56 is molded or otherwise fixed to the bottom of the table 50 and has a plurality of opposing teeth 58. The upper end of each leg 52 includes a T-shaped head 60 which is slidably received in the track 56. Resilient or spring bias detents 62 extend outwardly on opposite sides of the leg for selective receipt in one of the teeth 58. The detents 62 can be manually depressed so that the leg 52 can be slid inwardly or outwardly along the track 56 to a desired position. The detents 62 are then released into engagement with a pair of the opposing teeth 58. Thus, the radial spacing of the legs 52 can be quickly and easily adjusted so that the notches 54 will fit various containers 14. It is noted that in FIGS. 8 and 12, for illustrative purposes, two legs are shown to be at an inner or retracted position in the tracks, and two legs are shown to be at an outer or extended position in the tracks, though it is understood that usually the legs will be equally spaced from the center of the table for use on a round container.

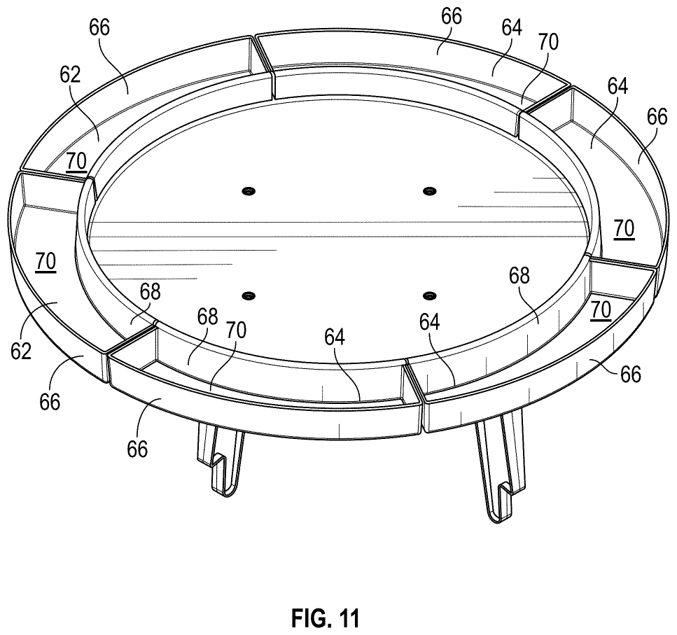

Optional organizer trays 64 are shown in FIGS. 11-13. The trays can be used on either table 12 or table 50. While FIGS. 11 and 12 show multiple trays 64 on the table 56 as to form a 360° ring around the perimeter of the table, it is understood that one or more trays 64 trays may be mounted on the table, as desired.

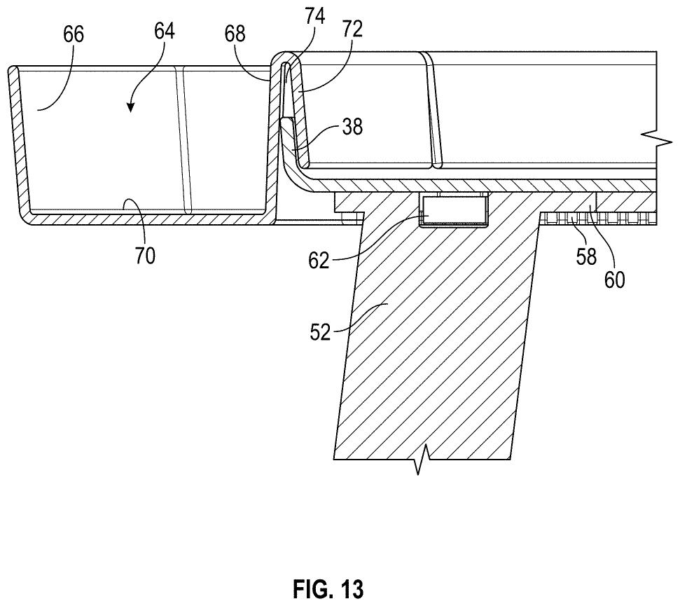

FIG. 13 shows a preferred construction of one of the trays 64. The trays 64 include an outer upright wall 66, and inner upright wall 68, and an interconnecting base or bottom wall 70, which together form a bin for holding small parts, tools, and other objects. A mounting leg or flange 72 is integrally formed with the inner wall 68 and spaced therefrom so as to form a channel 72 for receiving the lip 38 of the table 12, 50. Therefore, each tray 64 can be quickly and easily slip fit over the lip 38 for retention on the table 12, 50. It is understood that the dimensions and shape of the trays 64 may be varied from those shown in the drawings, without departing from the scope of the present invention.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

1: A table assembly, comprising:
a table top;
four support legs each having an upper and lower end, each leg extending downwardly from the table top to support the table top on a container;
each leg having a downwardly directed channel or a notch at the lower end, said channel or said notch adapted to receive an upper rim of the container so as to mount the table top on the container; and
a ratcheting mechanism positioned at the upper end of each leg, each ratcheting mechanism capable of adjusting the leg in a radial direction toward and away from a center of the table top along a bottom surface of the table top to a selected radial position for engagement with containers of various sizes, said ratcheting mechanism utilizing a resilient or spring biased member to retain the legs in said radial position; and
the radial positions of the legs being independently adjustable.

2-5. (canceled)

6: The table assembly of claim 1 wherein the table top includes an upstanding perimeter flange.

7: The table assembly of claim 6 further comprising at least one tray attached to the perimeter flange.

8: The table assembly of claim 1 wherein the table top includes holes for receiving objects.

9: The table assembly of claim 1 wherein the legs space the table top above the container rim.

10: The table assembly of claim 1 wherein the container is a garbage can.

11: A combination table and trash receptable assembly, comprising:
a container having a sidewall with an open upper end and a perimeter rim;
a table mounted to the rim of the container by a plurality of weight-bearing legs which support the table at a spaced distance above the container;
the legs being independently movable radially inwardly and outwardly to adjust spacing between all the legs so as to fit different sized trash receptacles;
a ratcheting mechanism for each let to selectively adjusting a radial position of the legs; and
a spring-biased detent associated with each leg and each ratcheting mechanism for retaining the leg in a selected radial position;
wherein the legs each having a lower end residing on the rim and along the sidewall of the container.

12-17. (canceled)

18: The combination of claim 11 wherein the container is a garbage can.

19: The combination of claim 11 wherein the legs have an inverted L-shaped notch to receive the rim of the container.

20: The combination of claim 11 wherein the container has wheels.

21. (canceled)

22: The table assembly of claim 1 wherein each of the legs slopes radially outwardly from top to bottom.
